(19) United States
(12) Patent Application Publication
(10) Pub. No.: US 2021/0043355 A1
(43) Pub. Date: Feb. 11, 2021

(54) Transformer Assembly and Method(s) of Use Thereof

(71) Applicant: Mark Allen Head, Bayfield, CO (US)

(72) Inventor: Mark Allen Head, Bayfield, CO (US)

(21) Appl. No.: 16/943,785

(22) Filed: Jul. 30, 2020

Related U.S. Application Data
(60) Provisional application No. 62/922,400, filed on Aug. 6, 2019.

(51) Int. Cl. H01F 27/00; H01F 27/28

(52) U.S. Cl. CPC H01F 27/004; H01F 27/2828

(57) ABSTRACT

A transformer assembly and method(s) of use thereof is described. Embodiments of the transformer assembly can include, but are not limited to, a transformer, a plurality of secondary bushings located on a secondary side of the transformer, a plurality of secondary probe blocks, and a plurality of secondary parking ports. The plurality of secondary probe blocks are each configured to be inserted into either one of the plurality of secondary bushings or one of the plurality of secondary parking ports. When inserted into the secondary bushing, the secondary probe block and associated service wires can be energized at a secondary voltage. When inserted into the secondary parking port, the secondary probe block and associated service wires will be de-energized.

### CROSS-REFERENCE TO RELATED APPLICATION

This application claims the benefit of U.S. Provisional Application No. 62/922,400, filed Aug. 6, 2019.

### BACKGROUND

Present day transformer design requires that connections between service wires and a transformer be electrically and physically disconnected at a secondary block of a transformer, particularly where the transformer or secondary blocks are being removed or replaced. Such interruption frequently requires disconnecting three separate secondary blocks, requiring disconnection of as many as 18 or more service wires before removing or servicing one transformer. Disconnecting and then reconnecting service wires for each secondary block is inefficient and it is frequently time consuming and tedious. Available solutions fail to meet the needs of the industry because of the time required to complete the service. The cumbersome service time adds to the overall time a customer(s) is without power. The current solution includes removing every service (or secondary) wire from all the secondary blocks by loosening a set screw for each wire, sometimes as many as 18, and reattaching the wires and retightening the set screws. This is very time consuming and leads to extended delays in returning power to a customer.

It is desirable to have a device that decreases labor time which is also safe and easy to use. Furthermore, it would also be desirable to have a device that is non-cumbersome and time consuming. A safe, easy, and quick way to remove service wires from a padmount transformer is needed.

### BRIEF DESCRIPTION OF THE DRAWINGS

FIG. 1A is a front view of a transformer assembly according to one embodiment of the present invention.

FIG. 1B is a front view of a transformer assembly according to one embodiment of the present invention.

FIG. 2A is a top view of a secondary probe block according to one embodiment of the present invention.

FIG. 2B is a side view of a secondary probe block according to one embodiment of the present invention.

FIG. 2C is a front view of a secondary probe block according to one embodiment of the present invention.

FIG. 2D is a back view of a secondary probe block according to one embodiment of the present invention.

FIG. 3 is a side view of a secondary probe block according to one embodiment of the present invention.

### DETAILED DESCRIPTION

Embodiments of the present invention include a transformer assembly and method(s) of use thereof. The transformer assembly can be implemented to allow for the quick, easy removal and parking of service wires (or secondary wires) for service and/or replacement of a transformer of the transformer assembly. The transformer assembly can typically include, but is not limited to, a transformer, a primary junction module, a primary bushing, a primary parking port, a medial wall, a plurality of secondary bushings, a plurality of secondary probe blocks, and a plurality of secondary parking ports.

The secondary probe blocks can be on a secondary side of the transformer assembly that enable interruption of secondary conductivity between a transformer and service wires by physically and electrically disconnecting the secondary probe blocks from the transformer. The secondary probe blocks, with service wires coupled thereto, can be physically removed from the secondary bushing and inserted into the secondary parking port. Accordingly, the number of secondary connections that must be disconnected in order to remove or replace a transformer is typically reduced where the transformer serves multiple service wires. The secondary probe blocks can provide a faster and more convenient alternative to the prior art practice of disconnecting each individual service wire from secondary blocks.

The secondary probe block can include, but is not limited to, a main body and a probe. The main body can include one or more bores for receiving a service wire therein. The service wire can be directly coupled to the main body when inserted into and coupled to the bore of the main body. The probe can be adapted to be inserted into a secondary bushing and connected to secondary transformer station on a secondary side of the transformer. In some instances, an end of the probe can include a non-conductive tip to prevent arcing when the secondary probe block is removed from the secondary bushing. The secondary probe block can be inserted into the secondary bushing making the electrical connection between the secondary side of a padmount transformer and service (or secondary) wires. The secondary probe block can be manufactured from one of many conductive materials.

Service wires may be added or removed to a de-energized secondary probe block without de-energizing the transformer of the transformer assembly. For instance, a secondary probe block can be removed and installed in a non-conductive location (e.g., a secondary parking port). The disclosed transformer assembly can allow for all secondary wires connected to a secondary probe block to be removed together from the secondary bushing at the same time, as opposed to individually removing each service wire from the secondary block, which is the current solution. Of note, there can be 3 to 4 secondary connection points (e.g., secondary blocks) on a typical padmount transformer and each connection point can have up to 6 wires connected to it.

The secondary bushing can be a port through which the secondary probe block can electrically connect to the secondary transformer station on the secondary side of the transformer. When the secondary probe block is inserted into the secondary bushing, a connection between the secondary side of the transformer and the secondary wires can be made. In one example, the secondary bushing can be attached to a cabinet (or case) of the transformer and allow the secondary probe block to pass through the cabinet without electrically connecting to the cabinet. The secondary bushing can be attached internally to the secondary side of the transformer. It should be noted that when the transformer is energized, the secondary transformer station will be energized at a secondary voltage allowing the secondary probe block, when passed through the secondary bushing, to be energized at the secondary voltage as well.

In a first configuration (an energized configuration), the secondary probe block can be inserted into the secondary bushing and conductively connected to the secondary transformer station. In a second configuration (a de-energized configuration), the secondary probe block can be removed and inserted into a secondary parking port. To remove the secondary probe block, the secondary probe block can be pulled out of the secondary bushing, thus de-energizing the secondary probe block. From there, the secondary probe block can be positioned in a non-conductive location before the transformer is removed or the attached service wires are repaired/replaced. It should further be noted that there may be more than one secondary bushing and secondary probe block on each transformer assembly.

Embodiments also include a kit for modifying an already existing transformer. Typically, the kit can include, but is not limited to, one or more secondary probe blocks, one or more secondary bushings, and one or more secondary parking ports. The kit may also include a medial wall adapted to fit into the transformer. In a typical installation, secondary blocks can be removed from the transformer and the secondary bushings can be installed where the secondary blocks were previously. Service wires can be removed from the secondary blocks and coupled to the one or more secondary probe blocks. The medial wall, including the secondary parking ports, can be installed into the transformer. The secondary probe block(s) can be inserted into the secondary bushing(s) and connected to the secondary transformer station on the secondary side of the transformer.

Embodiments also include a transformer that can be readily de-energized by interrupting primary power connectivity between a primary junction module and a transformer without de-energizing the primary junction module. Primary power to a transformer can thus be interrupted, but can continue through the primary junction module to other downstream transformers and primary devices.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The terms “electrical connector,” “electrical connectors,” “primary connector,” and “secondary connector,” as used in this specification and appended claims, refer to devices adapted to making electrical connections. Examples of electrical connectors include, but are not limited to, loadbreak elbows and probe blocks. Primary connectors are adapted to conduct primary voltage and secondary connectors are adapted to conduct secondary voltage.

The terms “parking port” or “parking ports,” as used in this specification and the appended claims, refer to devices adapted to safely receive an energized electrical connector such as a loadbreak elbow or a secondary probe block. The parking ports are electrical dead-ends (i.e., they are blind ports though which no current flows through even when an energized electrical connector is received thereupon). A parking port is not electrically connected to ground and does not participate in a closed electrical circuit, whether or not an energized electrical connector is received thereupon. An electrical connector received at parking port is said to be parked. A well-insulated, dead-end bushing adapted to receive an energized loadbreak elbow is an example of a parking port. A primary parking port is adapted to safely receive an electrical connector energized at primary or lower voltage. A secondary parking port is adapted to safely receive an electrical connector energized at secondary or lower voltage. It is understood that a parking port must be relatively well insulated from its surroundings in order to safely receive an energized electrical connector. When an electrical connector is parked at a parking port, it creates a readily apparent visual indication that a circuit is open. Such visual indication is beneficial for utility workers who need to know the status of a circuit.

The term “primary junction module station,” as used in this specification and appended claims, refers to a device disposed on a primary junction module and adapted to safely engage an electric connector such as a loadbreak elbow. The primary junction module station is in primary conductivity with a primary terminal on the primary junction module, and is adapted to engage a first primary loadbreak elbow.

The term “primary transformer station” as used in this specification and appended claims, refers to a device mounted on the transformer that is adapted to engage a primary connector, such as, but not limited to, a primary feeder. The primary transformer station is a means by which a primary side of the transformer is energized. Accordingly, the transformer is typically, but not necessarily, energized when the primary feeder is installed on the primary transformer station.

The term “secondary transformer station” as used in this specification and appended claims, refers to a device mounted on the transformer and adapted to engage a secondary connector such as, but not limited to, a secondary probe block. When the transformer is energized, the secondary transformer station is energized at a secondary voltage.

The terms “transformer” or “transformers,” as used in this specification and appended claims, refers to step-down transformers familiar to persons of ordinary skill in the art, adapted to reduce electric power at a primary voltage to electric power at a secondary voltage. A primary side of a transformer comprises transformer primary windings and other transformer components that operate at primary voltage, and a secondary side of the transformer comprises secondary windings and other transformer components that operate at secondary voltage. A transformer typically comprises an enclosure that protects and contains components, such as windings and cooling fluid.

The term “primary conductivity,” as used in this specification and appended claims, refers to electrical connectivity between structures such that electricity at primary voltage levels can be readily and substantially safely conducted between the structures. Structures that are in primary conductivity are electrically connected, and may or may not be actually conducting at electricity at primary voltage. Primary voltage is preferably greater than 1000 volts, more preferably greater than 1500 volts, still more preferably greater than 2000 volts, and most preferably falls in a range of 2,400 volts to 34,500 volts.

The term “secondary conductivity,” as used in this specification and appended claims, refers to electrical connectivity between structures such that electricity at secondary voltage can be readily and substantially safely conducted between the structures. Structures that are in secondary conductivity are electrically connected, and may or may not be actually conducting at electricity at secondary voltage. Secondary voltage is preferably less than 1000 volts and most preferably falls in a range of 100 volts to about 600 volts.

The terms “secondary block” or “secondary blocks,” as used in this specification, refer to components typically found in transformer assemblies currently in use. A typical transformer currently in use may have multiple secondary blocks. Each secondary block can have multiple connecting points for secondary or services wires. By this means, a typical transformer can serve multiple service wires.

The terms “secondary probe block” or “secondary probe blocks,” as used in this specification and the appended claims, refer to devices configured to be inserted into a secondary bushing and electrically connect to one or more service wires. The secondary probe block can be in secondary conductivity with the secondary transformer station when inserted into a secondary bushing.

The terms “secondary component” or “secondary components,” as used in this specification and the appended claims, refers to components relating to a secondary side of a transformer, including secondary transformer stations, secondary connecting members, service wires, and secondary connectors such as secondary probe blocks.

The term “elbow” as used in this specification and the appended claims, refers to an electrical connector familiar to persons skilled in the art. Elbows are typically found in pad mounted transformers, junction boxes, and other line equipment currently in use. Examples of elbows commonly in use are primary loadbreak elbows.

The terms “primary power line” and “primary power lines,” as used in this specification and appended claims, refer to lines adapted to carry primary power to or from a primary junction module. Accordingly, a primary power line can be a “source” line, in which case it conducts primary power to a primary junction module. Similarly, a primary power line can be a “load” line, in which case the primary power line conducts primary power away from the primary junction module. A person of ordinary skill in the art recognizes that for a transformer assembly to be energized, at least one primary power line electrically connected to the transformer assembly must be a source line. For the purposes of this specification and appended claims, a primary power line is deemed to include an appropriate electrical connector, such as but not limited to a primary loadbreak elbow, adapted to connect the primary power line to a primary terminal.

The terms “service wire,” “service wires,” “secondary wire,” and “secondary wires” as used in this specification and appended claims, refer to wires electrically connected to secondary probe blocks in order to carry electrical power at secondary voltage away from a transformer assembly. Service wires are typically used as a source of electrical power at secondary voltage to a user such as a business or home. The term “secondary wire” and “service wire” are sometimes used interchangeably by persons skilled in the art when referring to wires that operate at secondary voltage, which is typically, but not necessarily, falls in a range of 100 volts to 600 volts.

### A First Embodiment of a Transformer Assembly and Method(s) of Use Thereof

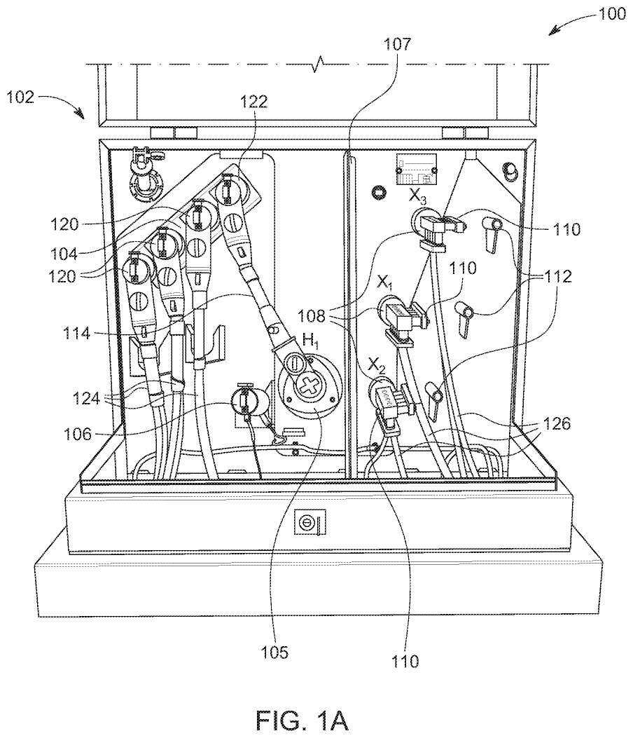

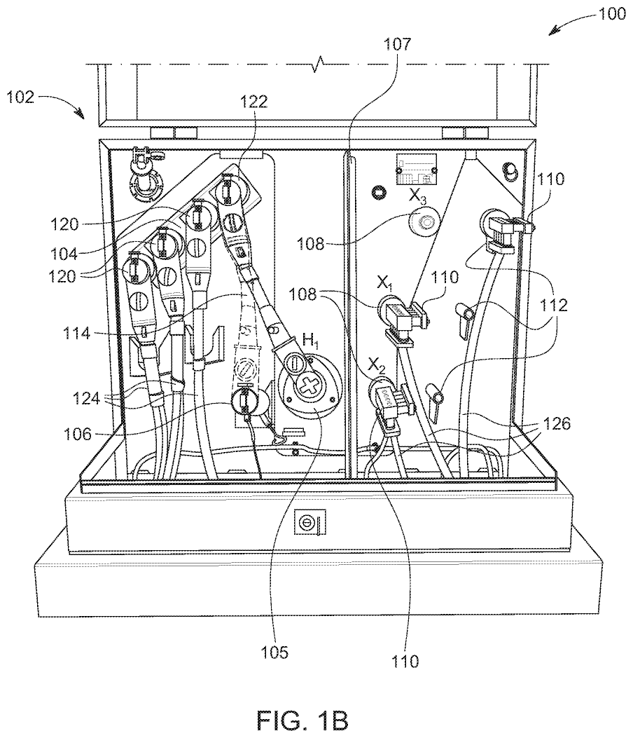

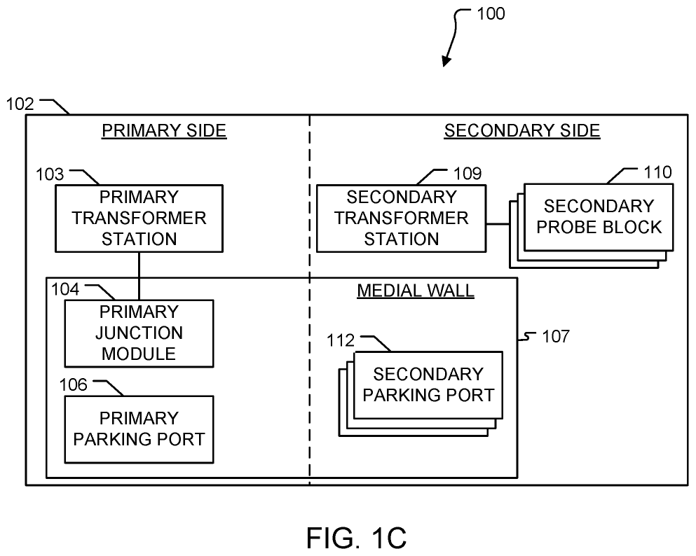

Referring to FIG. 1A, a detailed diagram of an embodiment 100 of a transformer assembly in a first configuration is illustrated. The transformer assembly 100 can be implemented to allow for quick, easy removal and parking of secondary wires (or cables) for service and/or replacement of the transformer assembly 100. The transformer assembly 100 can include a secondary probe block, having one or more secondary wires there attached, adapted to be easily removed and parked.

As shown in FIG. 1A, the transformer assembly 100 can include, but is not limited to, a transformer 102, a primary junction module 104, a primary bushing 105, a primary parking port 106, a medial wall 107, a plurality of secondary bushings 108 (blocked by secondary probe blocks), a plurality of secondary probe blocks 110, and a plurality of secondary parking ports 112.

The primary bushing 105 can provide an insulated port for a primary feeder 114 to electrically connect to a primary transformer station 103 (shown in FIG. 1C) of the transformer 102. The plurality of secondary bushings 108 can each provide an insulated port for the secondary probe blocks 110 to electrically connect to a secondary transformer station 109 (shown in FIG. 1C) of the transformer 102.

The primary feeder 114 can electrically connect the primary junction module 104 to the primary transformer station 103. Generally, the primary feeder 114 can include a first primary connector electrically connected to a second primary connector by a connecting conductor. In one instance, the first and second primary electrical connectors can be primary loadbreak elbows. The primary feeder 114 can be connected to a primary junction module station 122 of the primary junction module 104 and the bushing 105 of the transformer 102. The primary junction module 104 can include a plurality of primary terminals 120 and the primary junction module station 122. Of note, the primary junction module station 122 is partially obscured in FIG. 1 behind the primary loadbreak elbow of the primary feeder 114. A plurality of primary power lines 124 can conduct primary power to or from the primary junction module 104 via the primary terminals 120. One of the primary terminals 120 can be a source primary terminal and at least one of the primary terminals can be a load primary terminal. The source primary terminal receives primary power from a source primary power line and a load primary terminal energizes its load primary power line to carry primary power away from the primary junction module 104. The multiple primary terminals can be in primary conductivity with each other. In one example, primary voltage for the first embodiment transformer assembly can be about 7200 V. Generally, the primary feeder 114 can include a first primary connector electrically connected to a second primary connector by a connecting conductor. In one instance, the first and second primary electrical connectors can be primary loadbreak elbows.

The primary junction module 104, the primary parking port 106, and the plurality of secondary parking ports 112 can reside on the medial wall 107. The medial wall 107 can stand between the transformer 102 and the primary junction module 104, the primary parking port 106, and the plurality of secondary parking ports 112. As previously mentioned, the primary transformer station 103 and the secondary transformer station 109 can each reside on the transformer 102. The primary transformer station 103 can reside on a primary side and the secondary transformer station 109 can reside on the secondary side.

Each of the secondary probe blocks 110 can be configured to connect to a plurality of service wires 126. As will be described hereinafter, each of the plurality of secondary probe blocks 110 can be removed from the secondary bushing 108, and thus sever an electrical and physical connection between the plurality of service wires 126 coupled to the removed secondary probe block 110 and the secondary transformer station 109. Once the plurality of service wires 126 have been de-energized, the wires 126 can be safely repaired and/or replaced while the transformer 102 is still energized. Further, by physically removing the secondary probe block 110 from the secondary bushing 108 and inserting the secondary probe block 110 into the secondary parking port 112, a user may have immediate visual confirmation that the service wires 126 are de-energized and safe to interact with. As previously mentioned, when a transformer is currently serviced and/or replaced, each of the services wires must be removed from a secondary block. This includes separating all the service wires from the secondary block, which is very time consuming. In contrast, the secondary probe blocks 110 can be quickly and safely be removed from the secondary bushing 108 and de-energized.

When the plurality of secondary probe blocks 110 are connected to the secondary transformer station 109 via the plurality of secondary bushings 108 (partially hidden in FIG. 1 behind the plurality of secondary probe blocks 110), the secondary transformer station 109 can be in secondary conductivity with each of the plurality of secondary probe blocks 110. In such a configuration, each of the secondary probe blocks 110 can be adapted to deliver secondary power from the secondary side of the transformer 102 to the plurality of service wires 126.

Referring to FIG. 1B, a detailed diagram of the transformer assembly 100 in a second configuration is illustrated. In the second configuration, when the secondary service wires 126 need to be serviced, or the transformer 102 replaced/serviced, one of the plurality of secondary probe blocks 110 can be removed from the secondary bushing 108 and can be parked at one of the secondary parking ports 112. Of note, in instances where the transformer 102 is being replaced, the primary feeder 114 can be removed from the primary bushing 105 and moved to the primary parking port 106.

When a secondary probe block 110 is removed from the secondary bushing 108, a secondary conductivity (as well as a physical connection) between the secondary transformer station 109 of the transformer 102 and the secondary probe block 110 can be interrupted. Of note, the service wires 126 can remain coupled to the secondary probe block 110 and move with the secondary probe block 110 as the secondary probe block 110 is removed from the secondary bushing 108 and inserted into the secondary parking port 112. Typically, the secondary parking ports 112 can reside on the medial wall 107. It is to be appreciated that other configurations are contemplated. For instance, a floating parking port can be implemented.

In instances where the transformer 102 needs to be replaced and/or serviced, electrical connectivity can be severed between (i) the primary transformer station 103 and the primary feeder 114, and (ii) the secondary transformer station 109 and the plurality of secondary probe blocks 110. As shown in FIG. 1B, the primary feeder 114 can be removed from the primary bushing 105 and inserted into the primary parking port 106. Although only one of the secondary probe blocks 110 are shown removed from a secondary bushing 108, when the transformer 102 needs to be replaced, each of the plurality of secondary probe blocks 110 can be removed from respective secondary bushings 108 and inserted into a respective secondary parking port 112. With electrical connectivity and physical connectivity between the transformer 102 and the primary feeder 114 and the plurality of secondary probe blocks 110 absent, the transformer 102 can be removed from its close proximity to the medial wall 107 and a new transformer may be operatively installed. Removal of the transformer can further be facilitated by disconnecting a ground wire from grounding lugs. After the new transformer has been installed, the primary feeder 114 can be removed from the primary parking port 106 and inserted into a primary bushing of the new transformer. Similarly, each of the secondary probe blocks 110 can be removed from the secondary parking ports 112 and inserted into new secondary bushings of the new transformer.

Referring to FIG. 1C, a block diagram of the transformer assembly 100 is illustrated. As shown, the primary transformer station 103 can be on a primary side of the transformer 102 and can be connected to the primary junction module 104. The secondary transformer station 109 can be on a secondary side of the transformer 102 and can be connected to the secondary probe blocks 110. The medial wall 107 can provide an interface between the primary junction module 104, the primary parking port 106, and the plurality of secondary parking ports 112 from the transformer 102. Typically, the primary junction module 104 and the primary parking port 106 can be located on the primary side and the secondary parking ports 112 can be located on the secondary side.

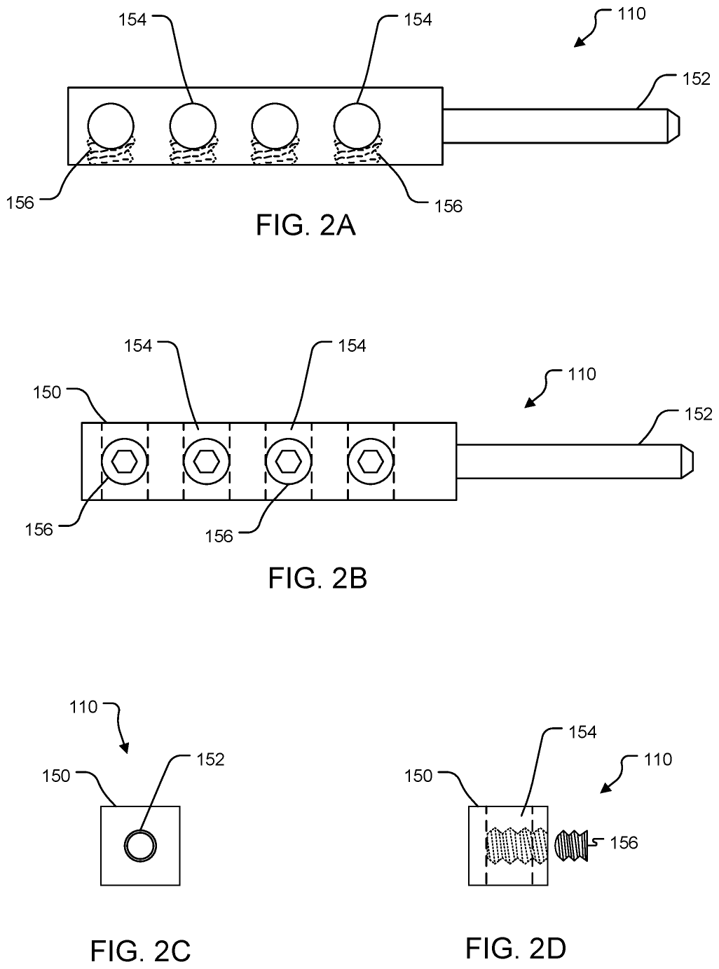

Referring to FIGS. 2A-2D, various views of one embodiment of the secondary probe block 110 are illustrated. FIG. 2A includes a top view of the secondary probe block 110. FIG. 2B includes a side view of the secondary probe block 110. FIG. 2C includes a front view of the secondary probe block 110. FIG. 2D includes a back view of the secondary probe block 110.

As shown generally in FIGS. 2A-2D, the secondary probe block 110 can include, but is not limited to, a main body 150, a probe 152, a plurality of bores 154, and a plurality of engagement members 156. The main body 150 and the probe 152 can be manufactured from an electrically conductive material. In some embodiments, the main body 150 and the probe 152 can be manufactured from a single piece of material. In other embodiments, the main body 150 and the probe 152 can be independently manufactured and then coupled together. For instance, the probe 152 may be threadably coupled to the main body 150. In another instance, the probe 152 may be friction fit to an aperture in the main body 150. In yet another instance, the probe 152 may be inserted into an aperture of the main body 150 and then secured to the main body 150 by one or more means.

The plurality of bores 154 can be configured to receive service wires (or cables) therein. Of note, although 4 boreholes are shown, it is to be appreciated that more or less bore holes can be provided. When a service wire is coupled to the main body 150 via the borehole 154 and the engagement member 156, the service wire can be conductively connected to the main body 150. When the probe 152 is inserted into a secondary bushing 108 and electrically connected to the secondary transformer station 109, the service wires connected to the secondary probe block 110 may be energized at the secondary voltage. When the secondary probe block 110 is removed from the secondary bushing 108, the service wires can be de-energized. When the service wires are de-energized, the secondary probe block can be serviced and/or the service wires can be serviced and/or replaced.

In one embodiment, the engagement members 156 may be set screws. Of note, other means for engaging electrical wires (or cables) may be implemented. As can be appreciated, the set screws 156 can be implemented to secure and electrically connect service wires to the main body 150. To connect a service wire to the main body 150, the engagement member 156 can be loosened such that the service wire may fit into the bore 154. Once the service wire is inserted sufficiently into the bore 154, the engagement member 156 can be tightened. To remove the service wire, the engagement member 156 can be loosened and the service wire may be pulled out of the bore 154.

As shown generally in FIGS. 2A-2D, one embodiment of the main body 150 of the secondary probe block 110 can have a substantially rectangular shape with a substantially square cross-section. It is to be appreciated that other shapes and sizes can be implemented without exceeding a scope of the present invention. In some instances, a length of the main body 150 may be determined based on the number of service wires to be connected. The probe 152 can have a substantially tubular shape with a circular cross-section. Generally, a length of the probe 152 can be sufficiently sized to be inserted through the secondary bushing 108 and electrically connect to the secondary transformer station 109 of the transformer 102.

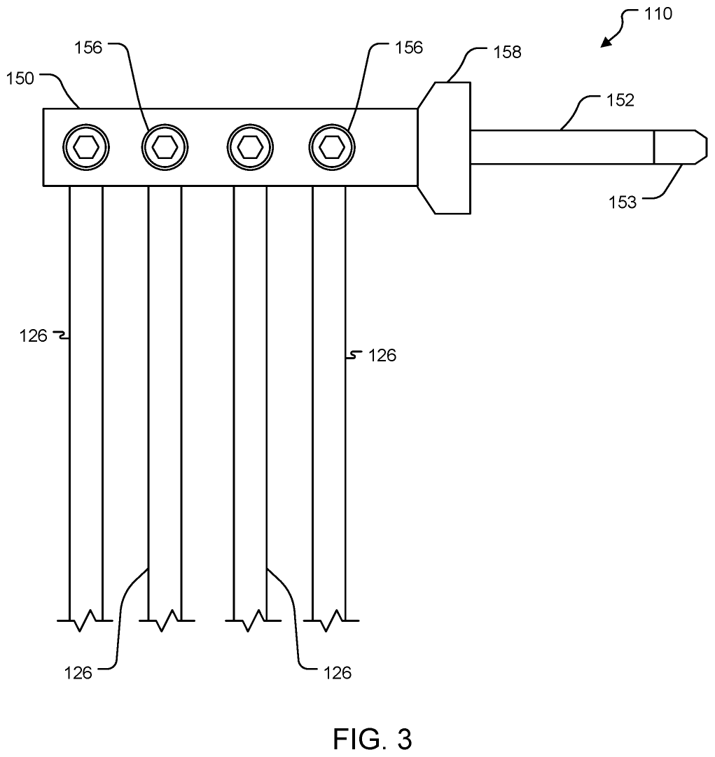

Referring to FIG. 3, a side view of an example secondary probe block 110 including a plurality of secondary service wires 126 is illustrated. As shown, the secondary probe block 110 can include an insulator 158 and a non-conductive tip 153. The non-conductive tip 153 can be implemented to decrease arcing when the secondary probe block 110 is removed from a secondary bushing 108.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A transformer assembly comprising:
a transformer including a primary side and a secondary side, the secondary side including a secondary transformer station energized at a secondary voltage;
a plurality of secondary probe blocks, each of the plurality of secondary probe blocks being in secondary conductivity with one or more service wires;
a plurality of secondary bushings providing an insulated port to the secondary transformer station; and
at least one secondary parking port, the secondary parking port being an electrical dead-end adapted to substantially safely receive one of the plurality of secondary probe blocks de-energized from secondary voltage;
wherein (i) in a first configuration, each of the plurality of secondary probe blocks are inserted into one of the plurality of secondary bushings and being electrically connected to the secondary transformer station; and (ii) in a second configuration, at least one of the plurality of secondary probe blocks is removed from one of the plurality of secondary bushings and inserted into the at least one secondary parking port.

2. The transformer assembly of claim 1, wherein the transformer assembly further includes:
a secondary parking port for each of the plurality of secondary probe blocks;
wherein in a third configuration, each of the plurality of secondary probe blocks are removed and inserted into one of the secondary parking ports.

3. The transformer assembly of claim 1, wherein each of the plurality of secondary probe blocks are defined by:
a main body having a substantially rectangular block shape, the main body including a plurality of bores for receiving a service wire therein; and
a probe coupled and in conductivity with the main body, the probe adapted to be inserted into one of the secondary bushings.

4. The transformer assembly of claim 3, wherein a distal end of the probe is non-conductive.

5. The transformer assembly of claim 1, wherein when one of the secondary probe blocks is inserted into the at least one secondary parking port, the secondary probe block is de-energized.

6. The transformer assembly of claim 5, wherein service wires connected to the de-energized secondary probe block are de-energized.

7. The transformer assembly of claim 6, wherein the de-energized service wires are serviced or replaced while one or more different secondary probe blocks and associated service wires are energized at secondary voltage.

8. The transformer assembly of claim 1, wherein each of the plurality of secondary probe blocks are directly coupled to the one or more service wires.

9. The transformer assembly of claim 1, wherein the service wires electrically connected to the secondary probe block are moved with the secondary probe block when the secondary probe block is moved from one of the plurality of secondary bushings to the at least one secondary parking port.

10. A transformer assembly comprising:
a transformer including a primary side and a secondary side, the secondary side including a secondary transformer station energized at a secondary voltage;
a plurality of secondary bushings providing an insulated port to the secondary transformer station;
a plurality of secondary probe blocks, each of the plurality of secondary probe blocks being (i) inserted into one of the plurality of secondary bushings, (ii) electrically connected to the secondary transformer station, and (iii) electrically connected with one or more service wires;
a medial wall;
a plurality of secondary parking ports located on the medial wall, each of the plurality of secondary parking ports being an electrical dead-end adapted to substantially safely receive one of the plurality of secondary probe blocks de-energized from secondary voltage.

11. The transformer assembly of claim 10, wherein the transformer assembly includes a configuration where each of the plurality of secondary probe blocks are removed from the respective secondary bushing and inserted into one of the plurality of secondary parking ports.

12. The transformer assembly of claim 10, wherein the plurality of secondary probe blocks are each energized at a voltage of the secondary transformer station.

13. The transformer assembly of claim 10, wherein each of the plurality of secondary probe blocks are defined by:
a main body being a substantially rectangular block with a substantially square cross-section, the main body including a plurality of bores; and
a probe coupled and in conductivity with the main body, the probe adapted to be inserted into one of the secondary bushings.

14. The transformer assembly of claim 10, wherein each of the plurality of bores are adapted to receive, conductively connect, and directly couple the service wire to the main body.

15. A method of working on a transformer assembly comprising:
servicing the transformer assembly, the transformer assembly including:
a transformer including a primary side and a secondary side, the secondary side including a secondary transformer station energized at a secondary voltage;
a plurality of secondary bushings providing an insulated port to the secondary transformer station;
a plurality of secondary probe blocks, each of the plurality of secondary probe blocks being (i) inserted into one of the plurality of secondary bushings, (ii) electrically connected to the secondary transformer station, and (iii) electrically connected with one or more service wires;
a plurality of secondary parking ports, each of the plurality of secondary parking ports being an electrical dead-end adapted to substantially safely receive one of the plurality of secondary probe blocks de-energized from secondary voltage;
removing a first secondary probe block from a first secondary bushing;
inserting a probe of the first secondary probe block into a first secondary parking port; and
servicing one or more service wires connected to the first secondary probe block.

16. The method of claim 15, further comprising the steps of:
removing a second secondary probe block from a second secondary bushing;
inserting a probe of the second secondary probe block into a second secondary parking port; and
servicing one or more service wires connected to the second secondary probe block.

17. The method of claim 16, further comprising the steps of:
removing the first secondary probe block from the first secondary parking port;
inserting the probe of the first secondary probe block into the first secondary bushing;
removing the second secondary probe block from the second secondary parking port; and
inserting the probe of the second secondary probe block into the second secondary bushing.

18. The method of claim 15, wherein the step of servicing the one or more service wires connected to the first secondary probe block includes replacing at least one of the one or more service wires with a new service wire.

19. The method of claim 15, further comprising the steps of:
removing each of the plurality of secondary probe blocks from respective secondary bushings;
inserting probes of the plurality of secondary probe blocks into parking ports;
removing the transformer;
installing a new transformer; and
inserting each of the plurality of secondary probe blocks into new secondary bushings of the new transformer.

20. The method of claim 15, wherein the one or more service wires connected to the first secondary probe block are de-energized when the first secondary probe block is inserted into the first secondary parking port.
